(19) United States
(12) Patent Application Publication
(10) Pub. No.: US 2024/0359910 A1
(43) Pub. Date: Oct. 31, 2024

(54) REFUSE VEHICLE WITH AN ACTIVE SERVICE INDICATOR

(71) Applicant: Oshkosh Corporation, Oshkosh, WI (US)

(72) Inventors: Derek Wente, Austin, MN (US); Jacob Wallin, Oshkosh, WI (US); Jerrod Kappers, Oshkosh, WI (US); Jerry Shirley, Oshkosh, WI (US); Jeremy Bernard, Oshkosh, WI (US); Aaron Hardy, Oshkosh, WI (US); Nick Weykamp, Oshkosh, WI (US); Vince Schad, Oshkosh, WI (US); Quincy Wittman, Oshkosh, WI (US); Joe Nelson, Oshkosh, WI (US); Ross Turner, Oshkosh, WI (US); Brian Thomas, Oshkosh, WI (US)

(73) Assignee: Oshkosh Corporation, Oshkosh, WI (US)

(21) Appl. No.: 18/647,563

(22) Filed: Apr. 26, 2024

Related U.S. Application Data
(60) Provisional application No. 63/462,782, filed on Apr. 28, 2023.

(51) Int. Cl. B65F 3/02

(52) U.S. Cl. CPC B65F 3/02; B65F 2003/0263; B65F 2210/168; B65F 2210/20

(57) ABSTRACT

A refuse vehicle includes a chassis, a body supported on the chassis, a pump, a tank configured to supply hydraulic fluid to the pump, and a service indicator configured to provide an indication of a fluid level within the tank. The service indicator includes a light, a graphic on a display, or a symbol in an augmented reality overlay. The service indicator is configured to provide the indication of the fluid level within the tank in response to a request signal.

### CROSS-REFERENCE TO RELATED PATENT APPLICATIONS

This application claims the benefit of and priority to U.S. Provisional Application No. 63/462,782, filed on Apr. 28, 2023, the entire disclosure of which is hereby incorporated by reference herein.

### BACKGROUND

Refuse vehicles (e.g., battery-powered refuse vehicles) typically include one or more vehicle subsystems, like a lift system or a compactor, that are hydraulically powered.

### SUMMARY

At least one embodiment relates to a refuse vehicle that includes a chassis, a body supported on the chassis, a pump, a tank configured to supply hydraulic fluid to the pump, and a service indicator configured to provide an indication of a fluid level within the tank. The service indicator includes a light, a graphic on a display, or a symbol in an augmented reality overlay. The service indicator is configured to provide the indication of the fluid level within the tank in response to a request signal.

Another embodiment relates to refuse vehicle that includes a chassis, a body supported on the chassis, a pump, a tank configured to supply hydraulic fluid to the pump, a temperature sensor configured to measure a temperature of the hydraulic fluid within the tank, a heater arranged within the tank and configured to selectively heat the hydraulic fluid within the tank, and a controller in communication with the temperature sensor and the heater. The controller is configured to measure, via the temperature sensor, a temperature of the hydraulic fluid within the tank, determine if a time to heat the hydraulic fluid to a predetermined preheat temperature is greater than or equal to a time until a scheduled start time, and upon determining that the time to heat the hydraulic fluid to the predetermined preheat temperature is greater than or equal to the time until the scheduled start time, instruct the heater to heat the hydraulic fluid in the tank to the predetermined preheat temperature.

Another embodiment relates to a method for preheating hydraulic fluid within a tank on a refuse vehicle. The method includes measuring a temperature of hydraulic fluid within a tank on a refuse vehicle, determining if a time to heat the hydraulic fluid to a predetermined preheat temperature is greater than or equal to a time until a scheduled start time of the refuse vehicle, and upon determining that the time to heat the hydraulic fluid to the predetermined preheat temperature is greater than or equal to the time until the scheduled start time, heating the hydraulic fluid in the tank to the predetermined preheat temperature.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a front loading refuse vehicle according to an exemplary embodiment;

FIG. 2 is a perspective view of a side loading refuse vehicle according to an exemplary embodiment;

FIG. 3 is a front perspective view of an electric front loading refuse vehicle according to an exemplary embodiment;

FIG. 4 is a right side view of the electric front loading refuse vehicle of FIG. 3;

FIG. 5 is a schematic view of a control system of the refuse vehicle of FIG. 3;

FIG. 6 is a schematic view of an electronic power take off (E-PTO) controller system according to an exemplary embodiment;

FIG. 7 is a perspective view of a modular E-PTO system for a refuse vehicle, according to an exemplary embodiment;

FIG. 8 is a perspective view of the modular E-PTO system of FIG. 7, according to an exemplary embodiment;

FIG. 9 is a side view of the modular E-PTO system of FIG. 7 installed on the refuse vehicle;

FIG. 10 is a side view of the modular E-PTO system of FIG. 7 removed from the refuse vehicle;

FIG. 11 is a perspective view of the modular E-PTO system of FIG. 7;

FIG. 12 is a block diagram of a refuse vehicle including a service indicator, according to an exemplary embodiment;

FIG. 13 is a perspective view of a refuse vehicle including a service indicator in the form of a multi-purpose light, according to an exemplary embodiment;

FIG. 14 is a schematic illustration of a service indicator in the form of a plurality of dedicated lights, according to an exemplary embodiment;

FIG. 15 is a schematic illustration of a service indicator in the form of a display graphic for a sensor failure or wire break, according to an exemplary embodiment;

FIG. 16 is a schematic illustration of a service indicator in the form of a display graphic for a battery state of charge or a battery charging fault, according to an exemplary embodiment;

FIG. 17 is a block diagram of a refuse vehicle including an external service indicator, according to an exemplary embodiment;

FIG. 18 is a perspective view of a refuse vehicle in communication with a mobile device, according to an exemplary embodiment;

FIG. 19 shows a service indicator in the form of an augmented reality overlay selecting a vehicle for service, according to an exemplary embodiment;

FIG. 20 shows a service indicator in the form of an augmented reality overlay identifying one or more components for service, according to an exemplary embodiment;

FIG. 21 shows a service indicator in the form of an augmented reality overlay identifying one or more components for service, according to an exemplary embodiment;

FIG. 22 shows a service indicator in the form of a table for a vehicle fleet, according to an exemplary embodiment;

FIG. 23 shows a service indicator in the form of a configurable list, according to an exemplary embodiment;

FIG. 24 is a schematic illustration of a tank of a refuse vehicle in communication with a level sensor and a status indicator, according to an exemplary embodiment;

FIG. 25 shows a graph illustrating an oil level as a function of a date, according to an exemplary embodiment;

FIG. 26 shows a graph illustrating an oil level as a function of time during vehicle operation, according to an exemplary embodiment;

FIG. 27 shows a service indicator for the tank of FIG. 24 in the form of light indicators, according to an exemplary embodiment;

FIG. 28 shows a service indicator for the tank of FIG. 24 in the form of a display graphic, according to an exemplary embodiment;

FIG. 29 show a service indicator for the tank of FIG. 24 in the form of a display graphic on a keypad, according to an exemplary embodiment;

FIG. 30 shows a service indicator for the tank of FIG. 24 in the form of a graph and a level indicator, according to an exemplary embodiment;

FIG. 31 is a block diagram of the tank of FIG. 24 including a heater, according to an exemplary embodiment;

FIG. 32 is a flowchart outlining the steps in a method for preheating fluid in the tank of FIG. 31, according to an exemplary embodiment;

FIG. 33 is a flowchart outlining the steps in a method for preheating fluid in the tank of FIG. 31, according to an exemplary embodiment; and

FIG. 34 is a flowchart outlining the steps in a method for preheating fluid in the tank of FIG. 31, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring to the FIGURES generally, the various exemplary embodiments disclosed herein relate to refuse vehicles and providing active service alerts for various components and/or subsystems on the refuse vehicle. In some embodiments, the active service alerts may be on demand and provided to a user or a display in response to a request. In some embodiments, the active service alerts may be provided automatically in response to a shift/route starting or ending, vehicle location, detection of a sensor/wire failure, and/or detection of a leak.

### Refuse Vehicle

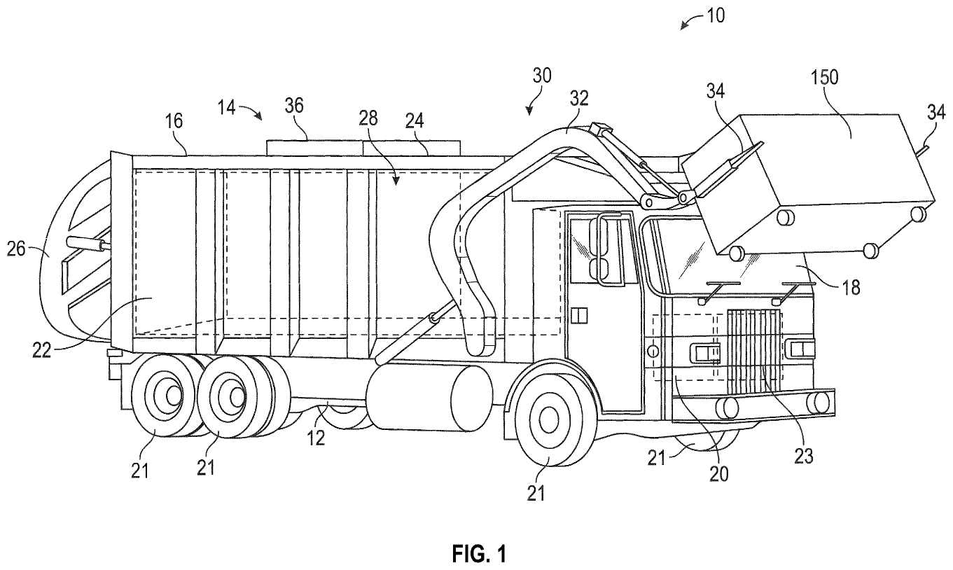

Referring to FIGS. 1-4, a vehicle, shown as refuse vehicle 10, also referred to as a refuse vehicle 10 throughout the application, (e.g., garbage truck, waste collection truck, sanitation truck, etc.), includes a chassis, shown as a frame 12, and a body assembly, shown as body 14, coupled to the frame 12. The body assembly 14 defines an on-board receptacle 16 and a cab 18. The cab 18 is coupled to a front end of the frame 12, and includes various components to facilitate operation of the refuse vehicle 10 by an operator (e.g., a seat, a steering wheel, hydraulic controls, etc.) as well as components that can execute commands automatically to control different subsystems within the vehicle (e.g., computers, controllers, processing units, etc.). The refuse vehicle 10 further includes a prime mover 20 coupled to the frame 12 at a position beneath the cab 18. The prime mover 20 provides power to a plurality of motive members, shown as wheels 21, and to other systems of the vehicle (e.g., a pneumatic system, a hydraulic system, etc.). In one embodiment, the prime mover 20 is one or more electric motors coupled to the frame 12. The electric motors may consume electrical power from an on-board energy storage device (e.g., batteries 23, ultra-capacitors, etc.), from an on-board generator (e.g., an internal combustion engine), or from an external power source (e.g., overhead power lines) and provide power to the systems of the refuse vehicle 10.

In some embodiments, the vehicle 10 is configured as a hybrid vehicle that is propelled by a hybrid powertrain system (e.g., a diesel/electric hybrid, gasoline/electric hybrid, natural gas/electric hybrid, etc.). According to an exemplary embodiment, the hybrid powertrain system may include a primary driver (e.g., an engine, a motor, etc.), an energy generation device (e.g., a generator, etc.), and/or an energy storage device (e.g., a battery, capacitors, ultra-capacitors, etc.) electrically coupled to the energy generation device. The primary driver may combust fuel (e.g., gasoline, diesel, etc.) to provide mechanical energy, which a transmission may receive and provide to a front axle and/or rear axles to propel the vehicle 10. Additionally or alternatively, the primary driver may provide mechanical energy to the generator, which converts the mechanical energy into electrical energy. The electrical energy may be stored in the energy storage device (e.g., the batteries 60) in order to later be provided to a motive driver.

In yet other embodiments, the chassis 12 may further be configured to support non-hybrid powertrains. For example, the powertrain system may include a primary driver that is a compression-ignition internal combustion engine that utilizes diesel fuel.

According to an exemplary embodiment, the refuse vehicle 10 is configured to transport refuse from various waste receptacles within a municipality to a storage or processing facility (e.g., a landfill, an incineration facility, a recycling facility, etc.). As shown in FIGS. 1-3, the body 14 and on-board receptacle 16, in particular, include a series of panels, shown as panels 22, a cover 24, and a tailgate 26. The panels 22, cover 24, and tailgate 26 define a collection chamber 28 of the on-board receptacle 16. Loose refuse is placed into the collection chamber 28, where it may be thereafter compacted. The collection chamber 28 provides temporary storage for refuse during transport to a waste disposal site or a recycling facility, for example. In some embodiments, at least a portion of the on-board receptacle 16 and collection chamber 28 extend over or in front of the cab 18. According to the embodiment shown in FIGS. 1-4, the on-board receptacle 16 and collection chamber 28 are each positioned behind the cab 18. In some embodiments, the collection chamber 28 includes a hopper volume 86 and a storage volume. Refuse is initially loaded into the hopper volume 86 and thereafter compacted into the storage volume. According to an exemplary embodiment, the hopper volume 86 is positioned between the storage volume and the cab 18 (i.e., refuse is loaded into a position behind the cab 18 and stored in a position further toward the rear of the refuse vehicle 10).

Referring again to the exemplary embodiment shown in FIG. 1, the refuse vehicle 10 is a front-loading refuse vehicle. As shown in FIG. 1, the refuse vehicle 10 includes a lifting system 30 that includes a pair of arms 32 coupled to the frame 12 on either side of the cab 18. The arms 32 may be rotatably coupled to the frame 12 with a pivot (e.g., a lug, a shaft, etc.). In some embodiments, actuators (e.g., hydraulic cylinders, etc.) are coupled to the frame 12 and the arms 32, and extension of the actuators rotates the arms 32 about an axis extending through the pivot. According to an exemplary embodiment, interface members, shown as forks 34, are coupled to the arms 32. The forks 34 have a generally rectangular cross-sectional shape and are configured to engage a refuse container (e.g., protrude through apertures within the refuse container, etc.). During operation of the refuse vehicle 10, the forks 34 are positioned to engage the refuse container (e.g., the refuse vehicle 10 is driven into position until the forks 34 protrude through the apertures within the refuse container). As shown in FIG. 1, the arms 32 are rotated to lift the refuse container over the cab 18. A second actuator (e.g., a hydraulic cylinder articulates the forks 34 to tip the refuse out of the container and into the hopper volume 86 of the collection chamber 28 through an opening in the cover 24. The actuator thereafter rotates the arms 32 to return the empty refuse container to the ground. According to an exemplary embodiment, a top door 36 is slid along the cover 24 to seal the opening thereby preventing refuse from escaping the collection chamber 28 (e.g., due to wind, etc.).

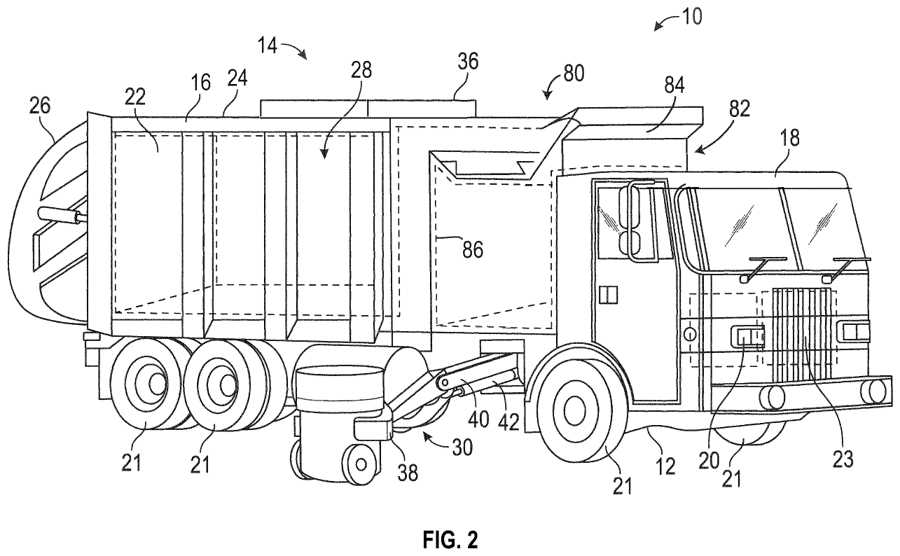

Referring to the exemplary embodiment shown in FIG. 2, the refuse vehicle 10 is a side-loading refuse vehicle that includes a lifting system, shown as a grabber 38 that is configured to interface with (e.g., engage, wrap around, etc.) a refuse container (e.g., a residential garbage can, etc.). According to the exemplary embodiment shown in FIG. 2, the grabber 38 is movably coupled to the body 14 with an arm 40. The arm 40 includes a first end coupled to the body 14 and a second end coupled to the grabber 38. An actuator (e.g., a hydraulic cylinder 42) articulates the arm 40 and positions the grabber 38 to interface with the refuse container. The arm 40 may be movable within one or more directions (e.g., up and down, left and right, in and out, rotation, etc.) to facilitate positioning the grabber 38 to interface with the refuse container. According to an alternative embodiment, the grabber 38 is movably coupled to the body 14 with a track. After interfacing with the refuse container, the grabber 38 is lifted up the track (e.g., with a cable, with a hydraulic cylinder, with a rotational actuator, etc.). The track may include a curved portion at an upper portion of the body 14 so that the grabber 38 and the refuse container are tipped toward the hopper volume 86 of the collection chamber 28. In either embodiment, the grabber 38 and the refuse container are tipped toward the hopper volume 86 of the collection chamber 28 (e.g., with an actuator, etc.). As the grabber 38 is tipped, refuse falls through an opening in the cover 24 and into the hopper volume 86 of the collection chamber 28. The arm 40 or the track then returns the empty refuse container to the ground, and the top door 36 may be slid along the cover 24 to seal the opening thereby preventing refuse from escaping the collection chamber 28 (e.g., due to wind).

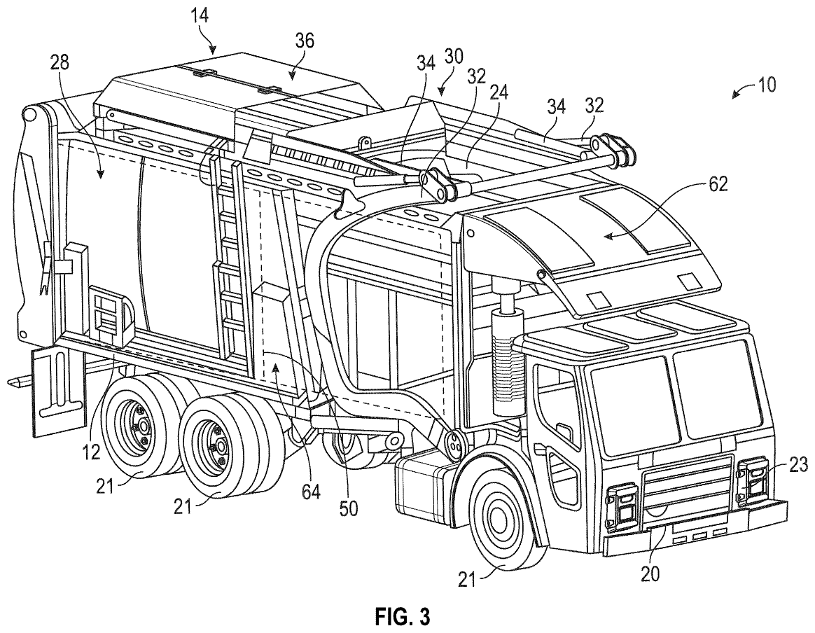

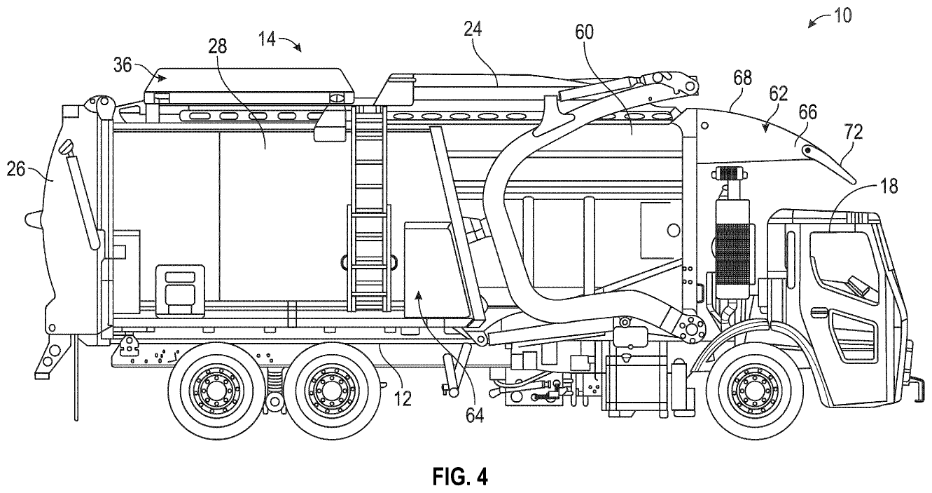

Referring to FIGS. 3-4, the refuse vehicle 10 is a front loading refuse vehicle 10. Like the refuse vehicle 10 shown in FIG. 1, the refuse vehicle includes a lifting system 30 that includes a pair of arms 32 coupled to the frame 12 on either side of the cab 18. The arms 32 are rotatably coupled to the frame 12 with a pivot (e.g., a lug, a shaft, etc.). In some embodiments, actuators (e.g., hydraulic cylinders, etc.) are coupled to the frame 12 and the arms 32, and extension of the actuators rotates the arms 32 about an axis extending through the pivot. According to an exemplary embodiment, interface members, shown as forks 34, are coupled to the arms 32. The forks 34 have a generally rectangular cross-sectional shape and are configured to engage a refuse container (e.g., protrude through apertures within the refuse container, etc.). During operation of the refuse vehicle 10, the forks 34 are positioned to engage the refuse container (e.g., the refuse vehicle 10 is driven into position until the forks 34 protrude through the apertures within the refuse container). A second actuator (e.g., a hydraulic cylinder) articulates the forks 34 to tip the refuse out of the container and into the hopper volume 86 of the collection chamber 28 through an opening in the cover 24. The actuator thereafter rotates the arms 32 to return the empty refuse container to the ground. According to an exemplary embodiment, a top door 36 is slid along the cover 24 to seal the opening thereby preventing refuse from escaping the collection chamber 28 (e.g., due to wind, etc.).

Still referring to FIGS. 3-4, the refuse vehicle 10 includes one or more energy storage devices, shown as batteries 23. The batteries 23 can be rechargeable lithium-ion batteries, for example. The batteries 23 are configured to supply electrical power to the prime mover 20, which includes one or more electric motors. The electric motors are coupled to the wheels 21 through a vehicle transmission, such that rotation of the electric motor (e.g., rotation of a drive shaft of the motor) rotates a transmission shaft, which in turn rotates the wheels 21 of the vehicle. The batteries 23 can supply additional subsystems on the refuse vehicle 10, including additional electric motors, cab controls (e.g., climate controls, steering, lights, etc.), the lifting system 30, and/or the compactor 50, for example.

### Electric Power Take-Off

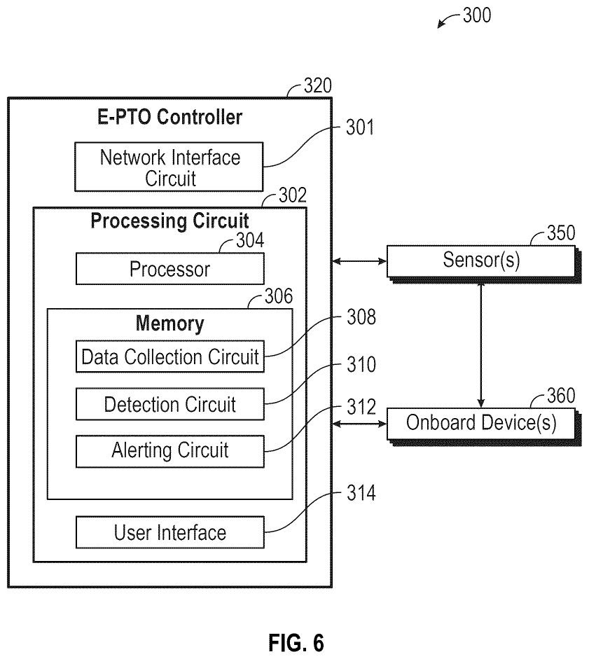

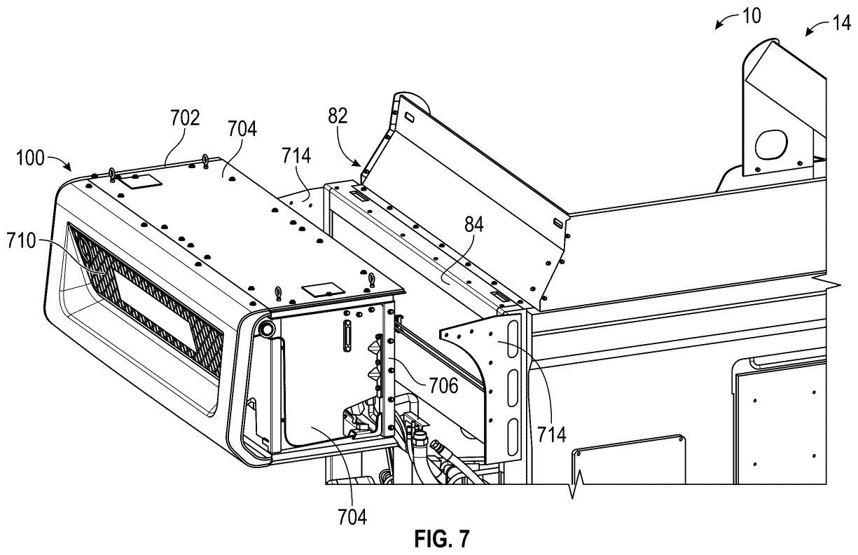

In some embodiments, the refuse vehicle 10 can be considered a hybrid refuse vehicle as it includes both electric and hydraulic power systems. As depicted in FIGS. 3-5, the refuse vehicle 10 includes an E-PTO system 100. The E-PTO system 100 is configured to receive electrical power from the batteries 23 and convert the electrical power to hydraulic power that can be used to power various other systems on the refuse vehicle 10. According to various embodiments, the E-PTO system 100 is self-contained within on the body of the refuse vehicle 10. For example, the E-PTO system 100 may be contained within a protective container (e.g., a fire resistant container) positioned on the refuse vehicle 10. The E-PTO system 100 includes an E-PTO sub-system 150 that includes various components of the E-PTO system 100, as will be discussed further herein. The E-PTO system 100 includes an E-PTO controller 320 configured to control and monitor (i.e., by receiving data from sensors) the components of the E-PTO sub-system 150 and various components of the refuse vehicle 10 as will be discussed in greater detail with reference to FIGS. 6 and 7. The E-PTO controller 320 may include a secondary battery such that the E-PTO controller 320 may operate independently of the battery 23. In some examples, the E-PTO system 100 includes an electric motor 104 driving a hydraulic pump 102. The hydraulic pump 102 pressurizes hydraulic fluid (e.g., oil) onboard the refuse vehicle 10, which can then be supplied to various hydraulic cylinders and actuators present on the refuse vehicle 10. For example, the hydraulic pump 102 can provide pressurized hydraulic fluid to each of the hydraulic cylinders within the lift system 30 on the refuse vehicle. Additionally or alternatively, the hydraulic pump 102 can provide pressurized hydraulic fluid to a hydraulic cylinder controlling the compactor 50. In still further embodiments, the hydraulic pump 102 provides pressurized hydraulic fluid to the hydraulic cylinders that control a position and orientation of the tailgate 26.

According to an exemplary embodiment, a tank or reservoir 114 supplies the hydraulic fluid to the hydraulic pump 102. In some embodiments, the tank 114 may be a component of the E-PTO system 100 and mounted within the modular housing 702 described herein. In some embodiments, the tank 114 may be coupled to or supported on the frame 12 and/or the body 14. In some embodiments, the vehicle 10 includes multiple tanks 114, for example, arranged in the modular housing 702 of the E-PTO system 100 and on the frame 12 or body 14.

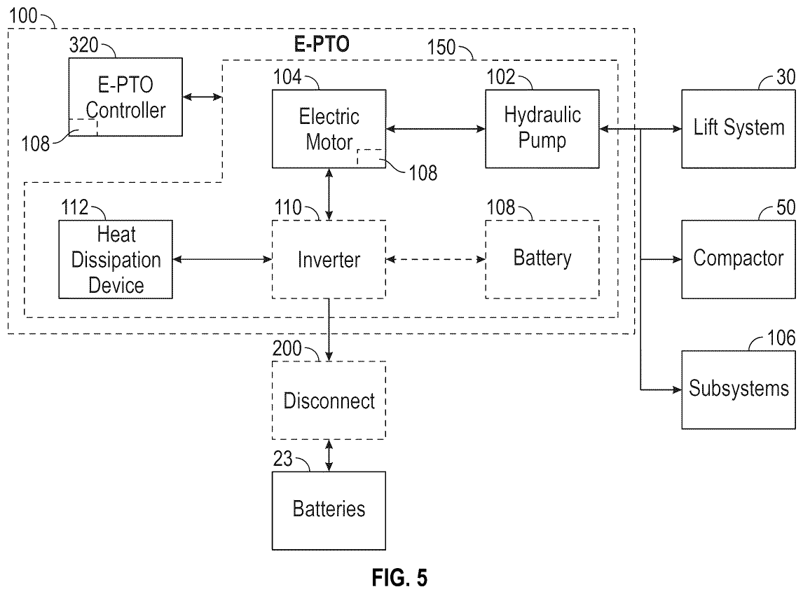

With continued reference to FIG. 5, the refuse vehicle 10 may include a disconnect 200 positioned between the batteries 23 and the E-PTO system 100. The disconnect 200 provides selective electrical communication between the batteries 23 and the E-PTO system 100 that can allow the secondary vehicle systems (e.g., the lift system, compactor, etc.) to be decoupled and de-energized from the electrical power source. For example, the E-PTO controller 320 may cause the disconnect 200 to be decoupled and de-energized from the electrical power source. The disconnect 200 can create an open circuit between the batteries 23 and the E-PTO system 100, such that no electricity is supplied from the batteries 23 to the electric motor 104 or the inverter 110 that is coupled to the electric motor 104 to convert DC power from the batteries 23 to AC power for use in the electric motor 104. Without electrical power from the batteries 23, the electric motor 104 will not drive the hydraulic pump 102. Pressure within the hydraulic system will gradually decrease, such that none of the lifting system 30, compactor 50, or vehicle subsystems 106 relying upon hydraulic power will be functional. The refuse vehicle 10 can then be operated in a lower power consumption mode, given the reduced electrical load required from the batteries 23 to operate the refuse vehicle 10. The disconnect 200 further enables the refuse vehicle 10 to conserve energy when the vehicle subsystems are not needed, and can also be used to lock out the various vehicle subsystems to perform maintenance activities.

The disconnect 200 further allows an all-electric vehicle chassis to be retrofit with hydraulic power systems, which can be advantageous for a variety of reasons, as hydraulic power systems may be more responsive and durable than fully electric systems. In some examples, the E-PTO system 100 includes a dedicated secondary battery 108 that is configured to supply electrical power to the E-PTO system 100 if the disconnect 200 is tripped, such that the secondary vehicle systems can remain optional even when the E-PTO system 100 is not receiving electrical power from the batteries 23. In some examples, the E-PTO system 100 operates independently of the battery 23, and includes its own dedicated secondary battery 108 that supplies DC electrical power to the inverter 110, which converts the DC electrical power to AC electrical power that can then be supplied to the electric motor 104. In still further embodiments, the dedicated secondary battery 108 is directly coupled to the electric motor 104 and supplies DC electrical power directly to the electric motor 104. With the secondary battery 108 present within the E-PTO system 100, the E-PTO system can be agnostic to the chassis type, and can be incorporated into all-electric, hybrid, diesel, CNG, or other suitable chassis types.

In certain embodiments, a heat dissipation device 112 is coupled to the inverter 110. The heat dissipation device 112 (e.g., a radiator, fan, etc.) is configured to draw heat away from the inverter 110 to reduce the risk of overheating. In certain embodiments, the heat dissipation device 112 is coupled to the inverter 110 via conduits. The conduits may be configured to transport a cooling fluid to and from the inverter 110. For example, the heat dissipation device may include a fluid pump configured to pump cooling fluid through the conduits. In certain embodiments, sensors may be positioned within or adjacent to the conduits. For example, the sensors may be configured to determine the flow rate of the cooling fluid through the conduits and/or the temperature of the cooling fluid flowing through the conduits, as will be discussed further below. It should be appreciated that the heat dissipation device 112 may also be coupled to various other components of the refuse vehicle 10.

Referring now to FIG. 6, an E-PTO controller system 300 is shown according to an example embodiment. For example, the E-PTO controller system may be implemented and used by the refuse vehicle 10. The E-PTO controller system 300 includes an E-PTO controller 320 (i.e., the E-PTO controller 320 from FIG. 5). The E-PTO controller system 300 may include one or more sensor(s) 350 configured to record data associated with various onboard device(s) 360. The sensor(s) 350 may include any type of sensor that may record data corresponding to the onboard device(s) 360, including a heat sensor (e.g., a thermocouple), a thermal vision camera, a thermometer, an electric current sensor, pressure sensors, fuel level sensors, flow rate sensors, voltage detectors, noise meters, air pollution sensors, mass flow rate sensors, etc. and any combination thereof. The onboard device(s) includes any equipment that is a part of the refuse vehicle 10, including the batteries 23, the tailgate 26, the lifting system 30, the top door 36, the grabber 38, the hydraulic cylinder 42, the compactor 50, the E-PTO system 100, the hydraulic pump 102, the electric motor 104, the dedicated secondary battery 108, the inverter 110, the heat dissipation device 112, the subsystems 106, E-PTO controller 320, and all sub components thereof.

In certain embodiments, each sensor 350 is configured to record data related to one or more onboard devices 360. For example, one or more a thermal sensors 350 may detect and record the temperature of the heat dissipation device 112 and/or the inverter 110. Further, one or more sensors 350 may be within or adjacent to the conduits that connects the heat dissipation device 112 to the inverter 110. In this example, the sensors 350, may determine the temperature (e.g., thermocouples, resistance temperature detectors, thermistors, semiconductor based on integrated circuits, etc.) and/or the fluid flow rate (e.g., a Coriolis meter, a differential pressure meter, a magnetic meter, a multiphase meter, a turbine meter, an ultrasonic meter, a vortex meter, a positive displacement meter, an electromagnetic flow meter, etc.) of the cooling fluid in the conduits. In certain embodiments, more than one sensor 350 is used to record data related to a single onboard device 360. For example, a thermal sensor 350 may detect and record the temperature of the inverter 110 and an electric flow sensor 350 may be used to record the current going into and/or out of the inverter 110.

In various embodiments, the E-PTO controller 320 is communicably coupled to sensor(s) 350, such that the data recorded by the sensor(s) 350 may be saved and analyzed. The E-PTO controller 320 is also communicably coupled to the onboard device(s) 360 such that the E-PTO controller 320 may control the onboard device(s) 360 (e.g., by sending operating parameters to the onboard devices). In certain embodiments, the E-PTO controller 320 includes a network interface circuit 301 configured to enable the E-PTO controller 320 to exchange information over a network. The network interface circuit 301 can include program logic that facilitates connection of the E-PTO controller 320 to the network (e.g., a cellular network, Wi-Fi, Bluetooth, radio, etc.). The network interface circuit 301 can support communications between the E-PTO controller 320 and other systems, such as a remote monitoring computing system. For example, the network interface circuit 301 can include a cellular modem, a Bluetooth transceiver, a radio-frequency identification (RFID) transceiver, and a near-field communication (NFC) transmitter. In some embodiments, the network interface circuit 301 includes the hardware and machine-readable media sufficient to support communication over multiple channels of data communication.

The E-PTO controller 320 is shown to include a processing circuit 302 and a user interface 314. The processing circuit 302 may include a processor 304 and a memory 306. The processor 304 may be coupled to the memory 306. The processor 304 may be a general purpose or specific purpose processor, an application specific integrated circuit (ASIC), one or more field programmable gate arrays (FPGAs), a group of processing components, or other suitable processing components. The processor 304 is configured to execute computer code or instructions stored in the memory 306 or received from other computer readable media (e.g., CDROM, network storage, a remote server, etc.).

The memory 306 may include one or more devices (e.g., memory units, memory devices, storage devices, etc.) for storing data and/or computer code for completing and/or facilitating the various processes described in the present disclosure. The memory 306 may include random access memory (RAM), read-only memory (ROM), hard drive storage, temporary storage, non-volatile memory, flash memory, optical memory, or any other suitable memory for storing software objects and/or computer instructions. The memory 306 may include database components, object code components, script components, or any other type of information structure for supporting the various activities and information structures described in the present disclosure. The memory 306 may be communicably connected to the processor 304 via processing circuit 302 and may include computer code for executing (e.g., by the processor 304) one or more of the processes described herein.

The data collection circuit 308 is configured to collect and store data collected by the sensor(s) 350. For example, the data collection circuit 308 may collect data during operation of the refuse vehicle 10, and store the data. Further, the collection circuit 308 is configured to store operating parameters that the E-PTO controller 320 may provide to onboard devices 360 to control the onboard devices 360. For example, the E-PTO controller 320 may provide operating parameters to the heat dissipation device 112 such that the E-PTO controller 320 may control the cooling fluid flow rate through the conduits. The operating parameters, for example, may be used to control the fluid pump within the heat dissipation device 112. For example, the operating parameters may increase or decrease the pumping rate of the fluid pump, thereby increasing or decreasing the flow rate of cooling fluid through the conduits. The data collection circuit 308 may also store normal operating conditions corresponding to each sensor 350. For example, the normal operating conditions may include a range of values measured by each sensor 350 that indicates an onboard device 360 is operating properly. For example, if initial operating parameters are provided to an onboard device 360, the normal operating conditions may be the expected senor 350 reading taken with respect to that onboard device 360. Further, the data collection circuit 308 is configured to store threshold measurements for each sensor 350. Each sensor 350 may have a different threshold measurement. In certain embodiments, the threshold measurement may represent both an upper threshold measurement (i.e., the upper bound) and a lower threshold measurement (i.e., a lower bound), such that a sensor 350 measurement below the lower bound or above the upper bound may be indicative of a critical event. The threshold measurement may represent a maximum (i.e., upper bound) and/or minimum acceptable (i.e., lower bound) value that may be detected by a sensor 350. The threshold measurement may depended on each onboard device's 360 demands (i.e., the onboard device 360 that the sensor 350 is monitoring). For example, a sensor 350 may be used to measure the cooling fluid temperature exiting the heat dissipation device 112. A predetermined threshold measurement may be defined for the sensor 350 and if the sensor 350 measures a reading above that threshold measurement, the E-PTO controller 320 may detect a critical operation. For example, the predetermined threshold measurement for the sensor 350 may represent the maximum acceptable temperature that the cooling fluid may safely reach without risking damage to the inverter 110 or the heat dissipation device 112. In another example, a sensor 350 may be used to measure the flow rate of the cooling fluid through the inverter 110. The threshold measurement for the sensor 350 may correspond with the minimum acceptable flow rate of the cooling fluid. For example, if the flow rate dropped below the threshold measurement, the inverter 110 or heat dissipation device 112 may be damaged.

The detection circuit 310 is configured to receive signals from sensor(s) 350 and compare this data to the data stored by the data collection circuit 308. For example, the detection circuit 310 may be able to identify if various components in a system (e.g., the E-PTO system 100, the lifting system 30, the compactor 50, subsystems 106, etc.) is in compliance (i.e., operating within the normal operating condition bounds). The detection circuit 322 is also configured to determine if a sensor 350 reading exceeds the threshold measurement. For example, detection circuit 310 may determine the presence of a critical operating condition if a sensor 350 detects the temperature of the inverter 110, or a region thereof, exceeds a predetermined threshold temperature. In some embodiments, detection circuit 310 detects a location of a critical operating condition. For example, detection circuit 310 may determine a critical operating condition is occurring in the inverter 110 because a sensor 350 detecting a temperature over the threshold temperature located proximate the inverter 110. In some embodiments, if the detection circuit 310 detects a critical operating condition, the critical operating condition, and the circumstances surrounding it, is communicated to the alerting circuit 312.

Alerting circuit 312 is configured to perform one or more operations in response to receiving an indication of a critical operating condition. In some embodiments, alerting circuit 312 presents an indication of the critical operating condition to an operator of refuse vehicle 10. For example, alerting circuit 312 may control a user interface 314 to display a warning to an operator of refuse vehicle 10.

The user interface 314 is configured to present information to and receive information from a user. In some embodiments, user interface 314 includes a display device (e.g., a monitor, a touchscreen, hud, etc.). In some embodiments, user interface 314 includes an audio device (e.g., a microphone, a speaker, etc.). In various embodiments, user interface 314 receives alerts from alerting circuit 312 and presents the alerts to an operator of refuse vehicle 10. For example, user interface 314 may receive a visual alert from alerting circuit 312 and display a graphic on a display device to alert an operator of refuse vehicle 10 of a critical operating condition and the location of the critical operating condition associated with the refuse vehicle 10.

In some embodiments, alerting circuit 312 operates refuse vehicle 10. For example, alerting circuit 312 may cause the E-PTO system 100 to shut down in response to a critical operating condition being detected with respect to a component of the E-PTO system 100. For example, if the cooling fluid flow rate through the inverter 110 is sensed (i.e., by a sensor 350) to be below a threshold measurement (i.e., as determined by the detection circuit 310), the alerting circuit 312 may cause the entire E-PTO system 100 to be shut down. Further, the alerting circuit 312 may cause the entire refuse vehicle 10 to shut down in response receiving an indication of a critical operating condition. Additionally or alternatively, alerting circuit 312 may transmit one or more notifications. For example, alerting circuit 213 may transmit a notification to the network interface circuit 301, such that a notification may be sent via the network to a fleet monitoring system that monitors the status of various refuse vehicles 10.

### Modular Electric Power Take-Off

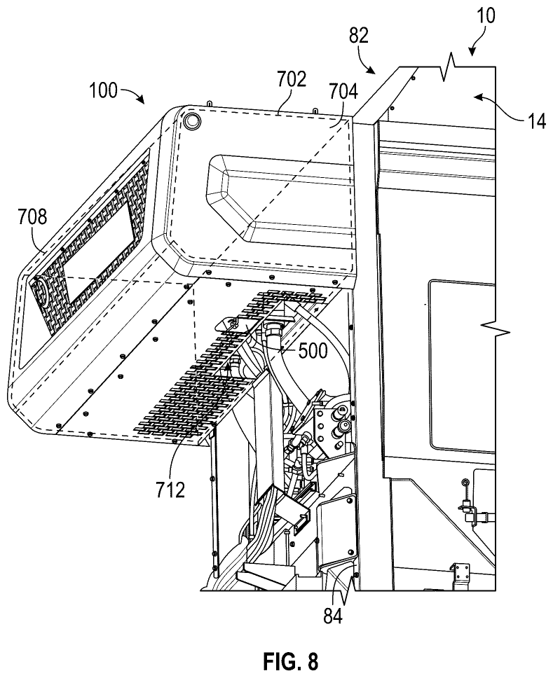

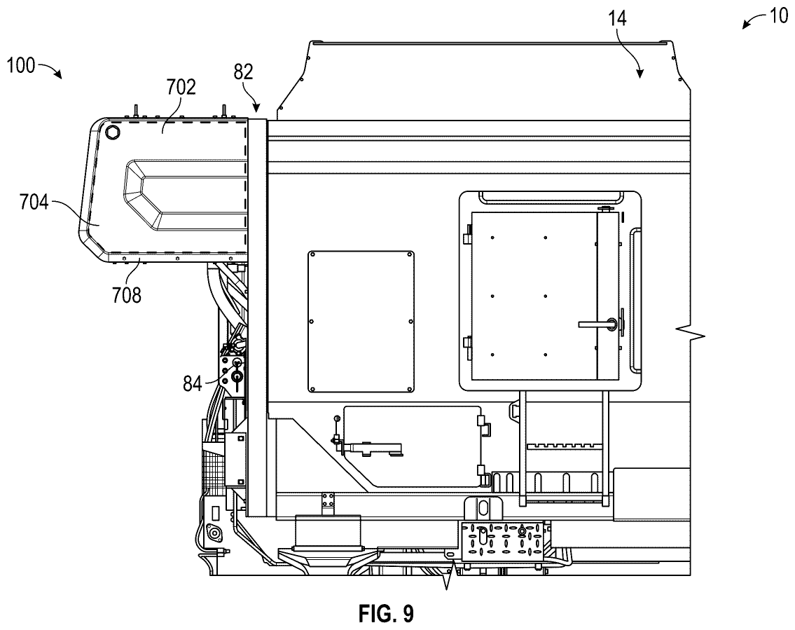

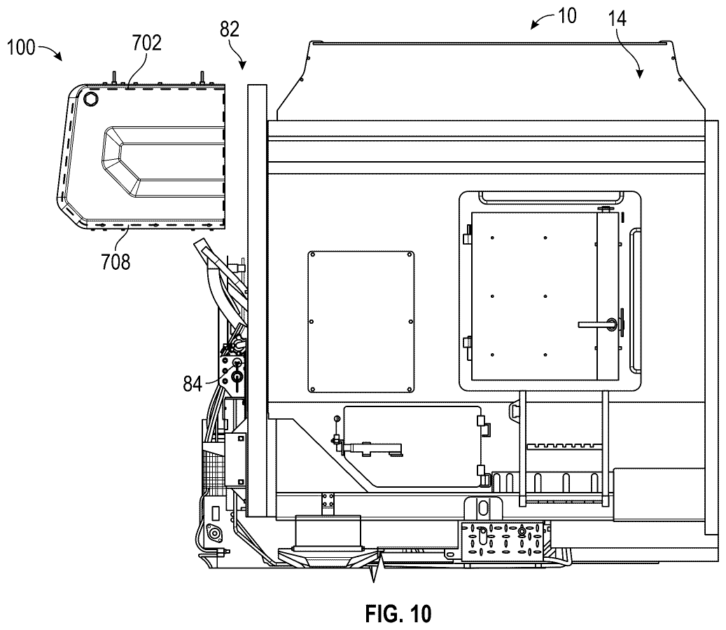

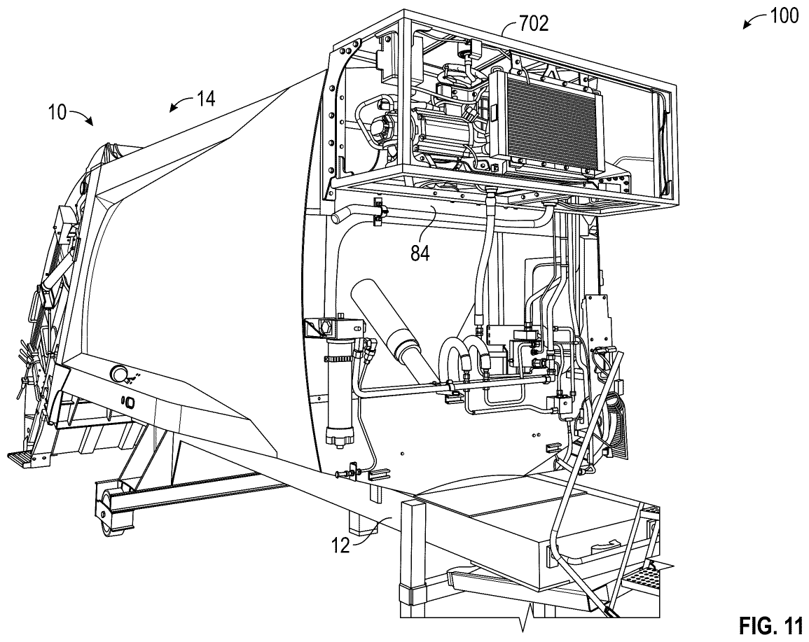

Referring to FIGS. 7-11, the E-PTO system 100 or the various components thereof may be physically provided on the refuse vehicle 10 in a modular housing 702 (e.g., a pod, a body, a capsule, a physically detachable assembly, an integral unit, a kit, etc.), according to some embodiments. The modular housing 702 may include one or more panels 704 (e.g., housing members, planar surfaces, plates, etc.) and one or more structural members 706 (e.g., support members, bars, beams, rails, etc.) onto which the panels 704 are coupled (e.g., fastened, attached, welded, etc.).

The panels 704 may define an inner volume 708 (e.g., a space, an area, a zone, a compartment, etc.) within which one or more of the components of the E-PTO system 100 are positioned. In some embodiments, the E-PTO sub-system 150 components are positioned within the inner volume 708. In some embodiments, the E-PTO controller 320 and the secondary battery 108 are positioned within the inner volume 708 of the modular housing 702. The modular housing 702 may include one or more sidewalls, that form or include a grating 710 (e.g., a mesh, an array of openings, multiple holes, etc.) to facilitate heat dissipation out of the modular housing 702 (e.g., heat that is generated by the battery 108). The grating 710 may be positioned in a direction of travel of the refuse vehicle 10 such that movement of the refuse vehicle 10 induces the transportation of air into the inner volume 708 of the modular housing 702 to thereby provide cooling for components of the E-PTO system 100. In some embodiments, the grating 710 is positioned directly in front of a radiator of the E-PTO system 100 (e.g., the heat dissipation device 112).

Referring still to FIGS. 7-11, the modular housing 702 may be coupled to a front wall or front portion 84 (e.g., a head board, a head frame, etc.) of a front end 82 of the body assembly 14. In some embodiments, the modular housing 702 is fastened onto the front portion 84 and removable from the front portion 84. The modular housing 702 may be positioned proximate (e.g., above) the cab 18. In some embodiments, the modular housing 702 is positioned on top of the body assembly 14 (e.g., above an upper surface, subflush with the upper surface of the body assembly 14). In some embodiments, the modular housing 702 is positioned at a rear end of the body assembly 14. The modular housing 702 can include one or more openings 712 so that one or more tubular members (e.g. hoses, hydraulic lines, etc.) and one or more cables (e.g., electrical cables, energy carrying cables, communications wires, etc.) can be coupled or connected to the corresponding components within the modular housing 702 (e.g., to electrically and/or hydraulically couple the compartment to the chassis 12 and/or other components of the refuse vehicle 10). For example, the cables may include high voltage (HV) and low voltage (LV) cables that electrically couple the inverter 110 with the batteries 23 or with a controller of the vehicle 10. In some embodiments, the modular housing 702 is also configured to receive a hydraulic hose through the opening 712 so that the various hydraulic components of the vehicle 10 (e.g., the lift system 30, the compactor 50, the subsystems 106, etc.) may be hydraulically coupled with the hydraulic pump 102 that is positioned within the modular housing 702. The opening 712 may be an elongated slot disposed on a lower wall of the modular housing 702 facing toward the chassis 12 of the refuse vehicle 10 or another location along the modular housing 702. In some embodiments, the connection points for the cables (e.g., the electrical cables) and the hydraulic lines are in proximity to each other at the modular housing 702 such that the cables and hydraulic lines can easily be connected or disconnected from a single position when installing or removing the modular housing 702. In some embodiments, the cables include a disconnect (e.g., a plug) at a position between the modular housing 702 and the body assembly 14 or chassis 12 of the refuse vehicle 10, such as proximate to the opening 712 of the modular housing 702.

Referring still to FIGS. 7-11, the modular housing 702 may be coupled with the body assembly 14 (e.g., at the front portion 84) via one or more connection members 714 that extend from the front portion 84. The connection members 714 (e.g., plates, planar surfaces, structural members, engagement members, etc.) may define one or more surfaces at opposite lateral ends of the body assembly 14. In some embodiments, the modular housing 702 may be positioned between the connection members 714 and fastened to the connection members 714 via bolts or another suitable fastener. In some embodiments, the modular housing 702 is configured to interlock with corresponding portions of the body assembly 14 or the connection members 714. For example, the modular housing 702 may include at least one quick disconnect such as clips, slotted openings (that support the modular housing 702 by its own weight on the chassis 12), quick release pins, and/or another type of quick disconnect to simplify removal of the modular housing from the chassis 12.

In some embodiments, the modular housing 702 is disposed on rails that extend from the body assembly 14 (e.g., the connection members 714 include rails) and the modular housing 702 rests upon the rails. In some embodiments, the modular housing 702 is disposed in a drawer assembly and includes quick connects/disconnects for the electric cables and the hydraulic lines. In some embodiments, the body assembly 14 includes a pan or a shelf that extends outwards from the body assembly 14 (e.g., at the front end 82 of the body assembly 14, at a rear end of the body assembly 14, on top of the body assembly 14, from lateral sides of the body assembly 14, etc.) and the modular housing 702 rests upon and is interlocked or fastened to the pan or the shelf. In still other embodiments, the modular housing 702 may be positioned on the chassis 12, between frame rails of the chassis 12, hung from the chassis 12, positioned on a shelf that extends laterally from sides of the chassis 12, etc. In some embodiments, the modular housing 702 is positioned within an inner volume of the body assembly 14, on the tailgate 26, above the tailgate 26, below the tailgate 26, beneath the cab 18, etc.

### Active Service Indicator(s)

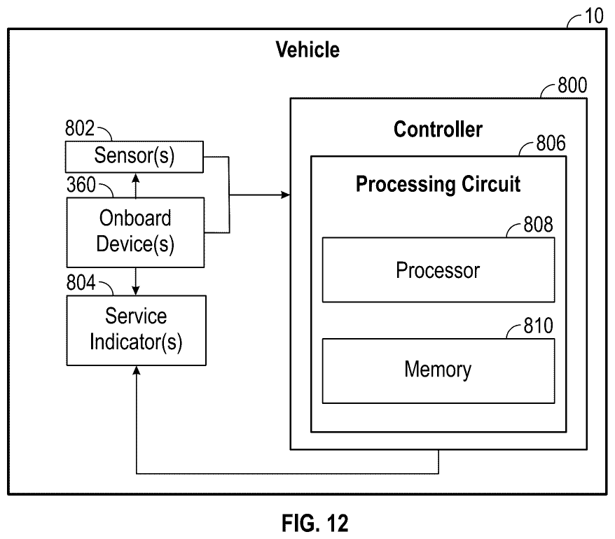

According to an exemplary embodiment, the vehicle 10 may include a service indicator(s) that is based on a status of a component, sensor, and/or a subsystem on the vehicle 10. In some embodiments, the vehicle 10 may include a plurality of service indicators, each being configured to provide an indication of a whether or not a component or subsystem is in need of service, and/or an indication of an operational status for a component or subsystem on the vehicle 10. By way of example, the vehicle 10 may include a controller 800 in communication with one or more sensors 802, and one or more service indicators 804, as shown in FIG. 12. In some embodiments, the controller 800 may include a plurality of controllers on the vehicle 10 (e.g., a battery controller or battery management system, a body controller, the E-PTO controller 320, etc.) with the combined functionality of the controllers being represented by the controller 800. In some embodiments, the controller 800 is a dedicated controller for the service indicator(s). The controller 800 includes a processing circuit 806 having a processor 808 and a memory 810. The processor 808 may be coupled to the memory 810. The processor 808 may be a general purpose or specific purpose processor, an application specific integrated circuit (ASIC), one or more field programmable gate arrays (FPGAs), a group of processing components, or other suitable processing components. The processor 808 is configured to execute computer code or instructions stored in the memory 810 or received from other computer readable media (e.g., CDROM, network storage, a remote server, etc.).

The memory 810 may include one or more devices (e.g., memory units, memory devices, storage devices, etc.) for storing data and/or computer code for completing and/or facilitating the various processes described in the present disclosure. The memory 810 may include random access memory (RAM), read-only memory (ROM), hard drive storage, temporary storage, non-volatile memory, flash memory, optical memory, or any other suitable memory for storing software objects and/or computer instructions. The memory 810 may include database components, object code components, script components, or any other type of information structure for supporting the various activities and information structures described in the present disclosure. The memory 810 may be communicably connected to the processor 808 via the processing circuit 806 and may include computer code for executing (e.g., by the processor 808) one or more of the processes described herein.

The sensors 802 may include the sensors 350 described herein and/or may include additional sensors on the vehicle 10, for example, an oil level sensor (e.g., the level sensor 902), a temperature sensor (e.g., the temperature sensor 922), and/or a state of charge sensor. In general, the service indicator(s) 804 may provide an audio, visual, and/or haptic indication of one or more of the sensors 802 and/or one or more of the onboard devices 360 requiring service. The requirement for service may be detected by the controller 800 based on the status of the sensors 802 (e.g., detection of a sensor/wire failure), a measurement from the sensors 802, or a status of an onboard device 360. The service indicator(s) 804 may provide a service indication based on a fluid level, a filter life, a fluid life, a pump pressure (e.g., of the hydraulic pump 102), a scheduled maintenance interval, a battery voltage (e.g., of the batteries 23 and/or battery 108), a battery state of charge (e.g., of the batteries 23 and/or battery 108), a battery temperature (e.g., of the batteries 23 and/or battery 108), a battery charger being connected, a high voltage interlock, a fluid temperature, an auto grease level, a tire pressure (e.g., within the wheels 21) and/or a status of one or more of the sensors 802.

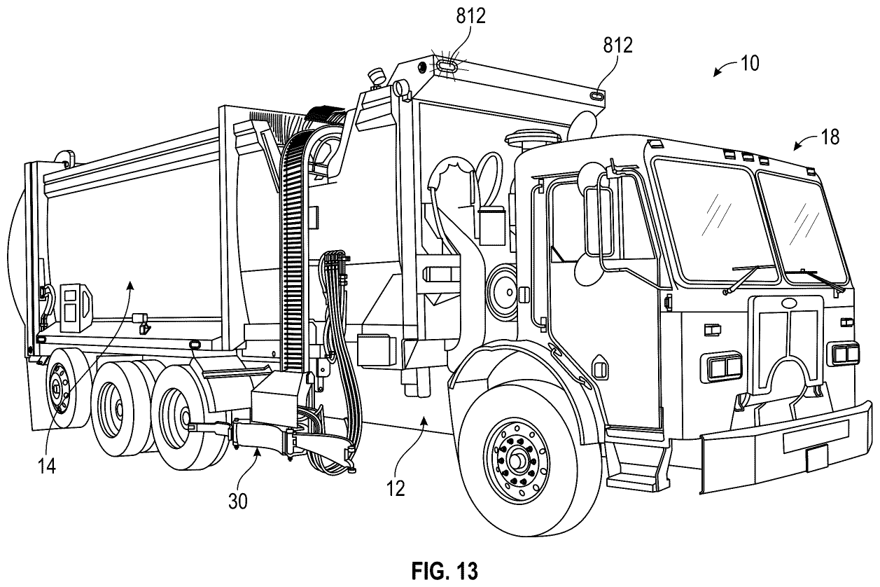

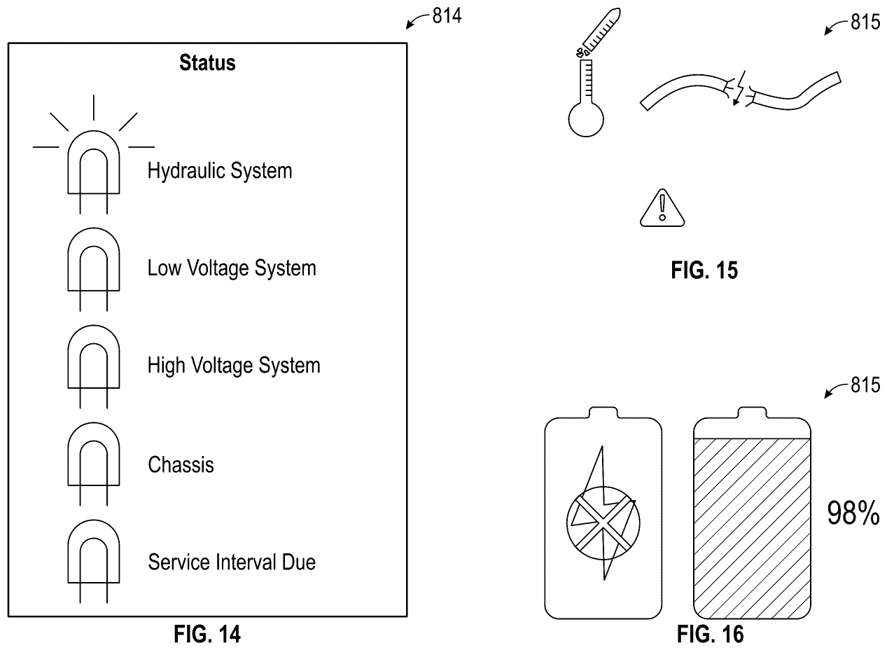

According to the exemplary embodiment of FIG. 12, the service indicator(s) 804 may be arranged on the vehicle 10. In some embodiments, the service indicator(s) 804 may be an audio, visual, and/or haptic component on the vehicle 10 that is either multi-purpose or dedicated to the service indicator(s) 804. By way of example, the service indicator 804 may include a multi-purpose light that is native to the vehicle 10, such as a clearance light 812 of the vehicle 10 as shown in FIG. 13. In some embodiments, the clearance light 812 may provide the service indicator 804 for one of the sensors 802 or onboard devices 360, and the other native lights on the vehicle 10 (e.g., headlights, turn-signal lights, clearance lights, etc.)) may provide the service indicators 804 for different sensors 802 or onboard devices 360. By way of another example, the service indicator(s) 804 may include a plurality of dedicated lights 814 that are dedicated to particular sensors 802 or the onboard devices 360, as shown in FIG. 14. In some embodiments, the dedicated lights 814 may be mounted on the body 14 or within the cab 18.

By way of yet another example, the service indicator(s) 804 may be provided on a dashboard or display that is within the cab 18. In some embodiments, the service indicator(s) 804 may include one or more of display graphics 815 that represents the sensor 802 or wire that failed (see, e.g., FIG. 15) or the onboard device 360 that is being monitored or requires service (see, e.g., FIG. 16 illustrated a battery state of charge (right) and that the battery is not charging (left)).

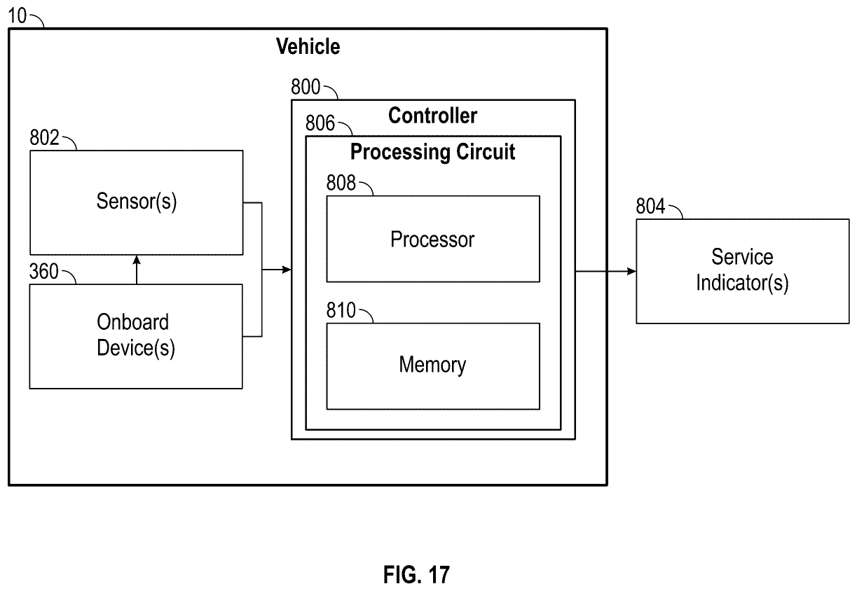

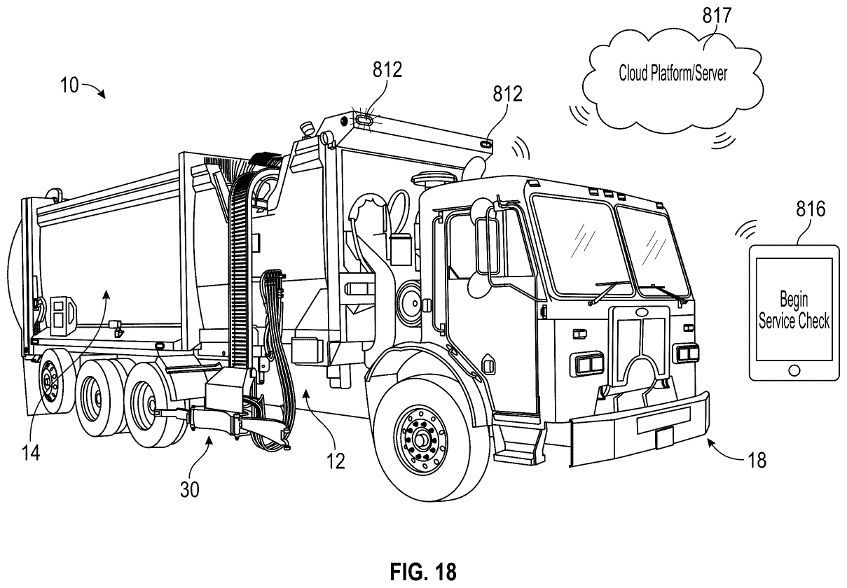

Alternatively or additionally, the service indicator(s) 804 may be provided on a mobile device 816 (e.g., a PDA, a cell phone, a tablet, a computer screen, etc.) or a dashboard that is arranged externally from the vehicle 10, as shown in FIGS. 17 and 18.

In some embodiments, the service indicator(s) 804 may be provided on demand in response to a user request. By way of example, the user request may be in the form of a soft key/digital buton on the mobile device 816 or the dashboard and/or a button or switch on the vehicle 10 (e.g., in the cab 18 or external to the cab 18). The digital key or the button/switch may be configured to send a request signal from the controller 800 to a cloud platform or sever 817 that then sends the request signal to the service indicator 804 and triggers the service indicator 804 to provide the status of a component, sensor 802, or onboard device 360. In some embodiments, the service indicator(s) 804 may be provided automatically in response to meeting predetermined criteria. By way of example, the service indicator(s) 804 may be provided based on a time of day (e.g., at the start of a shift or route, at the end of a shift or route, or based on a location of the vehicle 10). By way of another example, the service indicator(s) 804 may be provided upon a status of one or more of the sensors 802 or the onboard devices 360 indicating that service is required.

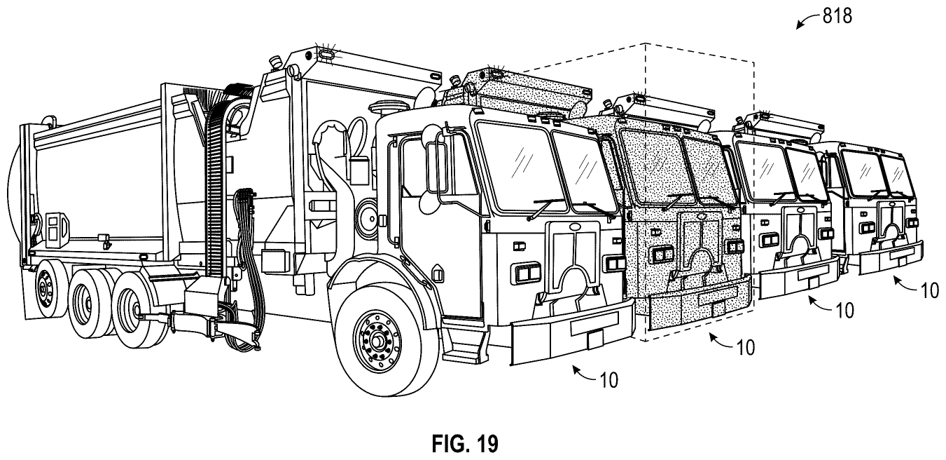

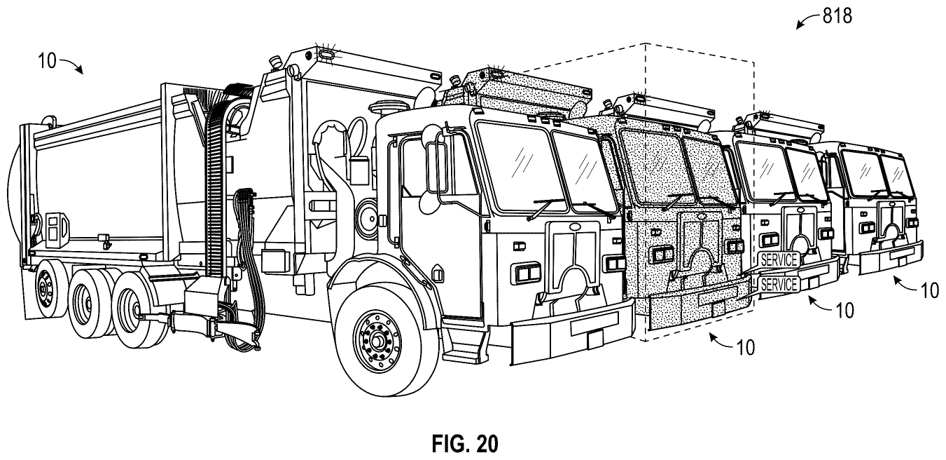

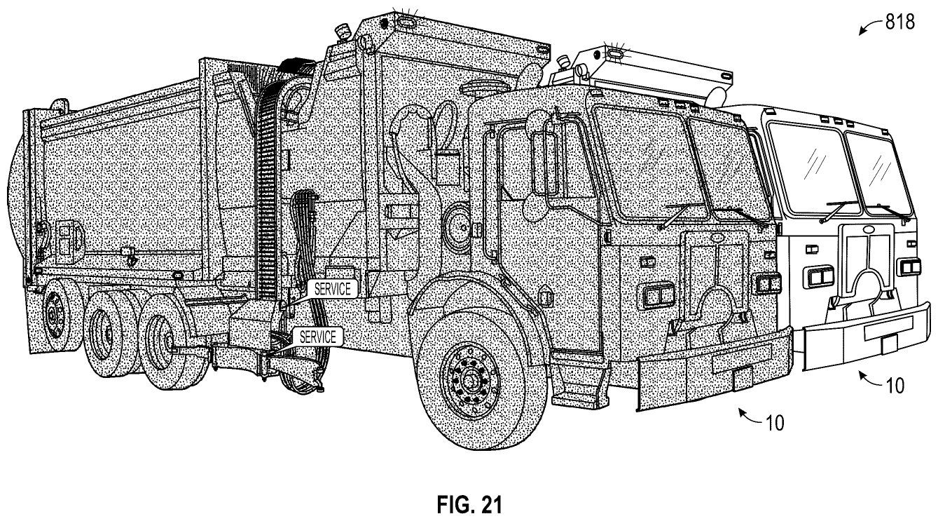

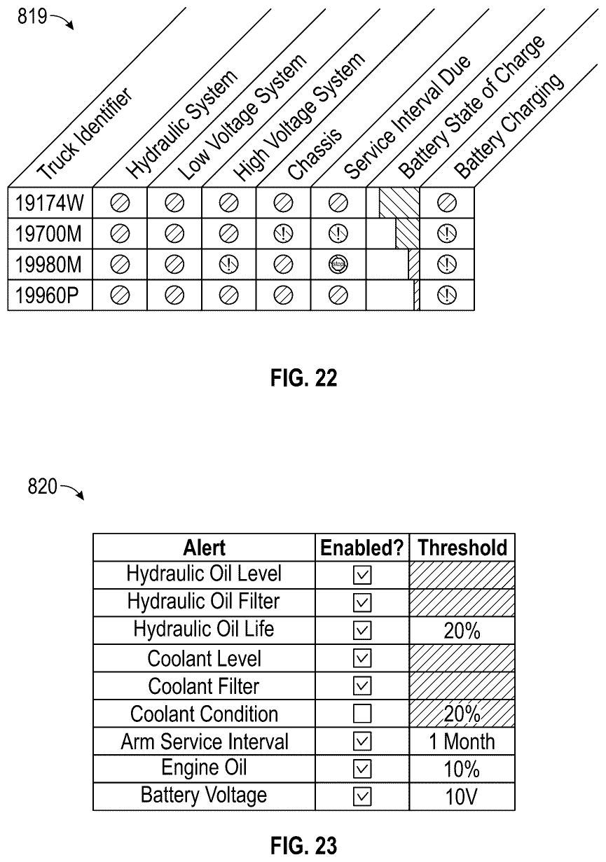

According to an exemplary embodiment, the service indicator(s) 804 may be displayed on an augmented reality overlay that is on the mobile device 816, the dashboard (e.g., arranged externally to or within the cab 18), and/or goggles or glasses worn by a user. FIGS. 19-21 show an exemplary embodiment of an augmented reality overlay 818 that is configured to identify a vehicle 10 within a vehicle fleet that needs service by highlighting the vehicle and/or placing a dashed box around the vehicle, as shown in FIG. 19. By way of example, the service indicator(s) 804 may be in the form of text bubbles that pop up on the highlighted vehicle and point to the sensor 802 or onboard device 360 that requires service, as shown in FIGS. 20 and 21. By way of another example, the service indicator(s) 804 may include a display table 819 (see, e.g., FIG. 22) that includes columns and rows for various vehicles within a vehicle fleet that is displayed on the mobile device 816, the dashboard (e.g., arranged externally to or within the cab 18), and/or goggles or glasses worn by a user.

In some embodiments, the service indicator(s) 804 may include configurable settings that determine if a particular service indicator 804 is active and define a threshold for when an indication for service is detected by the controller 800 and communicated by the service indicator(s) 804. FIG. 23 illustrates an exemplary embodiment of a configurable table 820 that may be displayed on the mobile device 816, the dashboard (e.g., arranged externally to or within the cab 18), and/or goggles or glasses worn by a user.

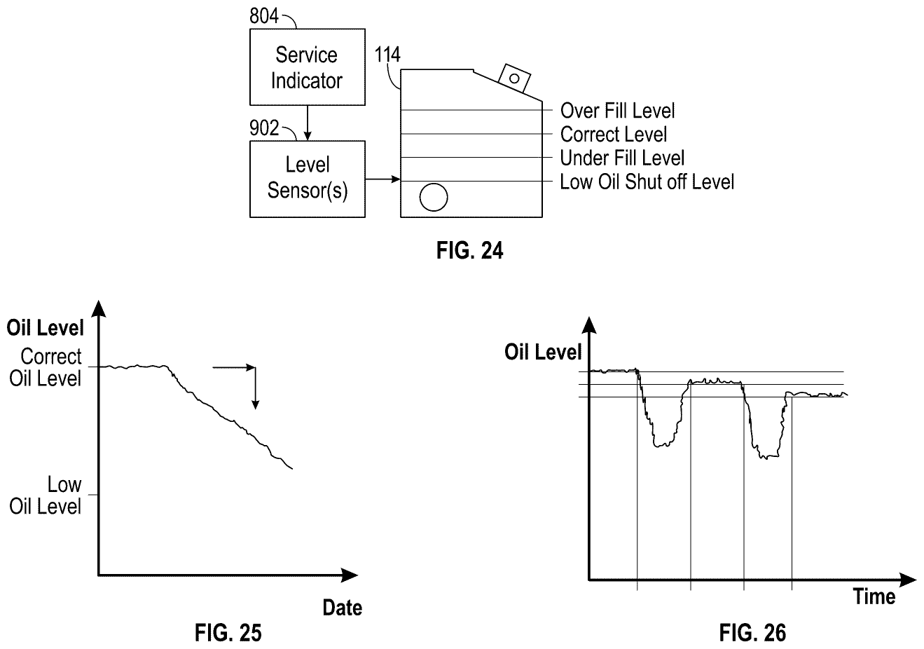

In some embodiments, a sight glass of the tank 114 (e.g., located within the modular housing 702 or coupled to the chassis 12 or the body 14) may be difficult to view (e.g., by an operator within the cab 18 or walking around the vehicle 10), which results in the oil level within the tank 114 being difficult to check during routine operation of the vehicle 10. As shown in FIGS. 24-26, the tank 114 may define one or more levels that are associated with both filling the tank 114 and the use of the oil within the tank 114. By way of example, the tank 114 may define an overfill level, a correct or desired fill level, an underfill level, and a low-shutoff fill level (see, e.g., FIG. 24). The oil level within the tank 114 may be measured by a level sensor 902. By way of example, the level sensor 902 may include individual fluid level switches that trigger when the oil level within the tank 114 is below each of the respective levels (e.g., the overfill level, the correct or desired fill level, the underfill level, and the low-shutoff fill level). In some embodiments, the tank 114 includes a fluid level sensor that continuously monitors the oil level within the tank 114.

The oil level in the tank 114 may fluctuate during operation and as the tank 114 is filled or re-filled. For example, FIGS. 25 and 26 show exemplary embodiments of the oil level in the tank 114 decreasing from day to day (e.g., FIG. 25) or over time during a shift (e.g., FIG. 26). According to an exemplary embodiment, the service indicator 804 may be configured to provide an indication of an oil level within the tank 114.

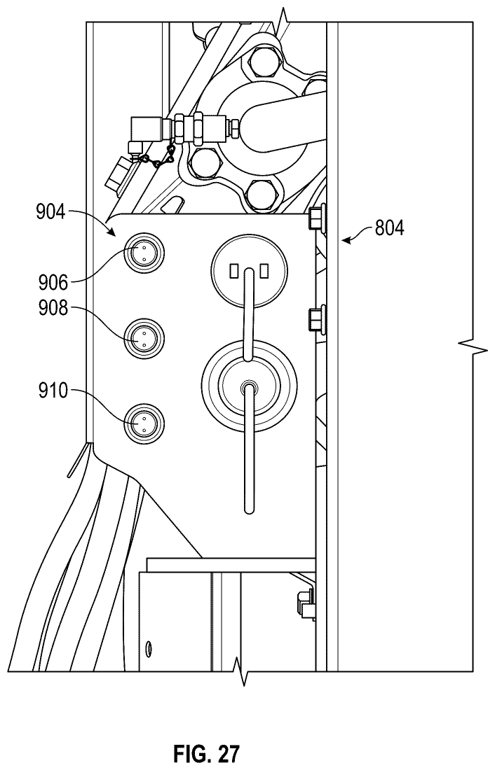

In general, the service indicator 804 may be configured to provide a visual, audible, and/or haptic indication of the fluid level within the tank 114. As described herein, the service indicator(s) 804 may provide an indication for a whether or not a sensor 802, onboard device 360, and/or subsystem is in need of service, and/or an operational status for a component or subsystem on the vehicle 10. FIG. 27 shows an exemplary embodiment of a service indicator 804 that includes a plurality of light indicators 904. By way of example, the plurality of light indicators 904 may include an overfill indicator 906 that corresponds with the over fill level in the tank 114, a correct indicator 908 that corresponds with the correct fill level in the tank 114, and an underfill indicator 910 that corresponds with the underfill level in the tank 114. By way of another example, the overfill indicator 906 is above the correct indicator 908, and the correct indicator 908 is between the overfill indicator 906 and the underfill indicator 910. In some embodiments, the service indicator 804 is in communication with the level sensor(s) 902 and illuminates one of the overfill indicator 906, the correct indicator 908, or the underfill indicator 910 that corresponds with the current oil level within the tank 114.

In some embodiments, each of the plurality of light indicators 904 are in the form of an LED. In some embodiments, the service indicator 804 is mounted to the front wall 84 (e.g., the head frame) of the vehicle 10 so an operator can easily view the service indicator. In some embodiments, the service indicator 804 is mounted within the cab 18. In some embodiments, the service indicator 804 is mounted remotely from the tank 114 (e.g., not attached to the structure that houses the tank 114).

According to an exemplary embodiment, the light indicators 904 may be selectively activated to indicate the oil level within the tank 114, which prevents the light indicator 904 that corresponds with the current oil level from being constantly illuminated during operation of the vehicle 10. By way of example, the vehicle 10 may include a button or switch (e.g., mounted within the cab 18, or mounted to the body 14) that triggers at least one of the light indicators 904 to illuminate and provide an indication of the oil level in the tank 114 by illuminating the one of the overfill indicator 906, the correct indicator 908, or the underfill indicator 910 that corresponds with the current oil level within the tank 114. In some embodiments, the button or switch may send a request signal to the service indicator 804 to trigger one of the light indicators 904 to illuminate. In some embodiments, the button or switch may send a request signal to the controller 800 and the controller 800 instructs the service indicator 804 to trigger one of the light indicators 904 to illuminate. In some embodiments, the button or switch may be a digital button or switch on a mobile device (e.g., the mobile device 816 described herein).

According to an exemplary embodiment, the low-shutdown fill level in the tank 114 is not incorporated into the service indicator 804 and is integrated into the alerting circuit 312 so that when the low-shutdown fill level is detected by the fluid level switch or fluid level sensor, the E-PTO system 100 and/or the vehicle 10 shutdown.

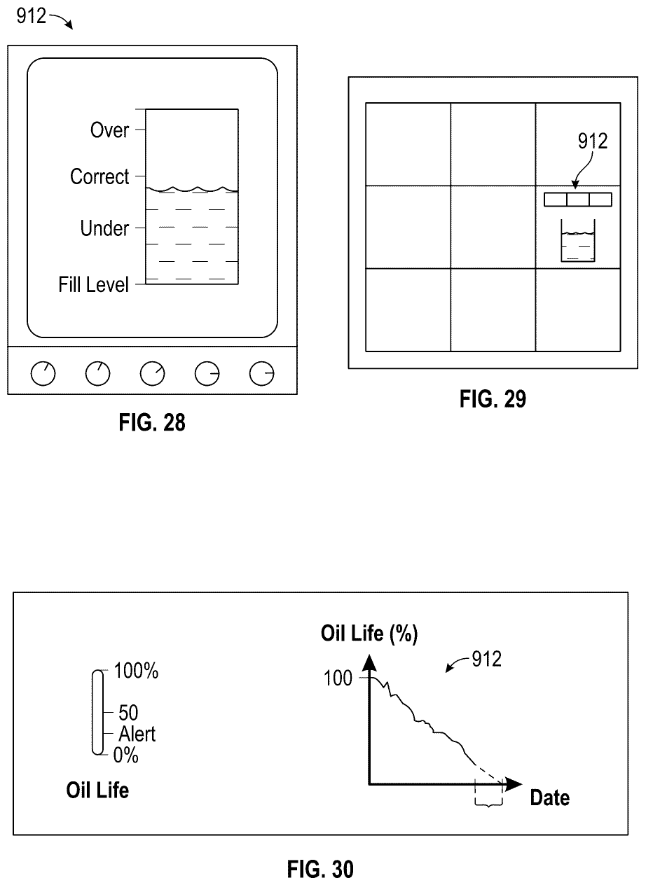

According to an exemplary embodiment, the service indicator 804 is incorporated into a user interface (e.g., the user interface 320, the mobile device 816, a display on a dash within the cab 18, etc.) so that the service indicator 804 is in the form of a display graphic 912 where the oil fill level is shown in real time, as shown in FIG. 28. Alternatively or additionally, the display graphic 912 may be integrated into a keypad of the vehicle 10, as shown in FIG. 29. In some embodiments, the display graphic 912 may, alternatively or additionally, include a level indicator with a percentage that the tank 114 is full and/or a graph representing the oil level over time, as shown in FIG. 30.

In some embodiments, the data from the level sensor(s) 902 may be communicated to the E-PTO controller 320, a body controller (e.g., a processor and memory that control operation of the body 14 and the components coupled thereto (hydraulic actuators, etc.)), the controller 800, and/or to a telematics controller that manages a fleet of vehicles. By way of example, the oil level may be tracked over time, for example, by the E-PTO controller 320, the body controller, the controller 800 and/or the telematics controller to detect leaks in the hydraulic circuit on the vehicle 10 over time. In some embodiments, the oil level may be tracked before and after repeatable hydraulic functions operations (e.g., operation of hydraulic actuators controlled by the body controller such as the actuators or lift cylinders of the lift system 30) to determine if a leak exists in the portion of the hydraulic circuit that corresponds with that particular hydraulic function (see, e.g., FIG. 26 showing decreasing oil level after function operation, which is depicted by the oil level dropping and then rising).

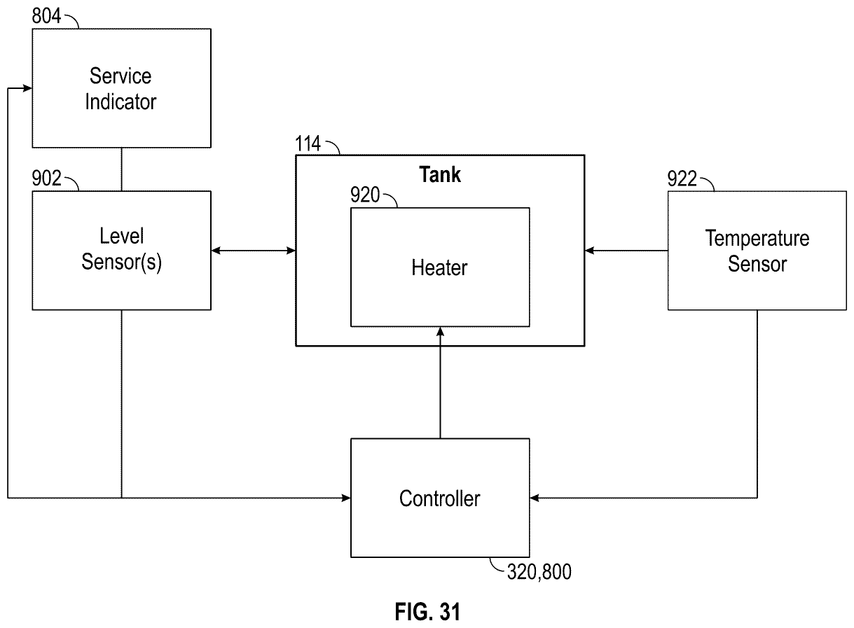

According to an exemplary embodiment, the vehicle 10 is configured to perform a preheating process for the oil within the tank 114. By way of example, the tank 114 may include a heater 920 (e.g., a resistive heater, a ceramic heaters, or an equivalent electric heater, etc.) that is configured to heat the oil within the tank in response to activation by a controller (e.g., the controller 800, the E-PTO controller 320, etc.), as shown in FIG. 31. In some embodiments, the heater 920 is powered by the battery 23. In some embodiments, the heater 920 is powered by the secondary battery 108. A temperature of the oil within the tank 114 is measured by a temperature sensor 922 that is communication with the controller 320, 800. In general, preheating the oil within the tank 114 may bring the oil to working temperature prior to the vehicle 10 leaving on a route to improve fluid and filter conditions.

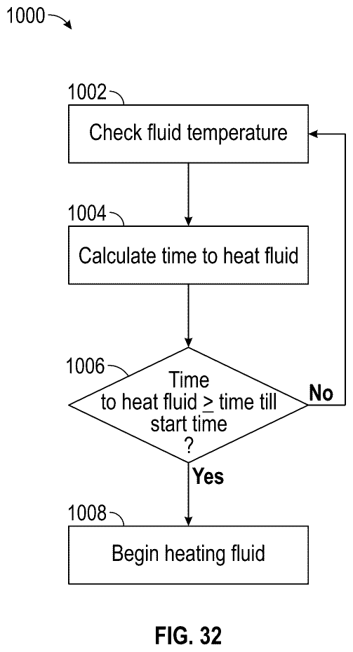

FIG. 32 shows a method 1000 of preheating the oil within the tank 114, according to an exemplary embodiment. In some embodiments, the method 1000 may be performed by the E-PTO controller 320 or the controller 800. The method 1000 may begin at step 1002 where a temperature of the oil within the tank 114 is measured by the temperature sensor 922. At step 1004, a time to heat the oil within the tank 114 from the measured temperature to a predetermined preheat temperature is calculated or determined at step 1004. In some embodiments, the time to heat the oil to the predetermined preheat temperature may be based on fluid specific heat, volume, heater power, and measured temperature. In some embodiments, the time to heat the oil to the predetermined preheat temperature may be done with an interpolation table that is based on the measured temperature (e.g., oil starting at X temperature takes Y minutes).

Once the time to heat the oil is calculated at step 1004, the controller determines, at step 1006, if the time to heat the oil is approximately greater than or approximately equal to a time until the vehicle 10 starts (e.g., beginning of a shift, beginning of a planned route, a programmed start time in the controller 800, or a programmed start time in a telematics controller). If the time to heat the oil is approximately greater than or approximately equal to the time before the vehicle 10 starts, the heater 920 is instructed to heat the oil to the predetermined preheat temperature at step 1008 (e.g., the controller 320, 800 is configured to supply power from the battery 23 or the secondary battery 108 to the heater 920 before the vehicle 10 starts).

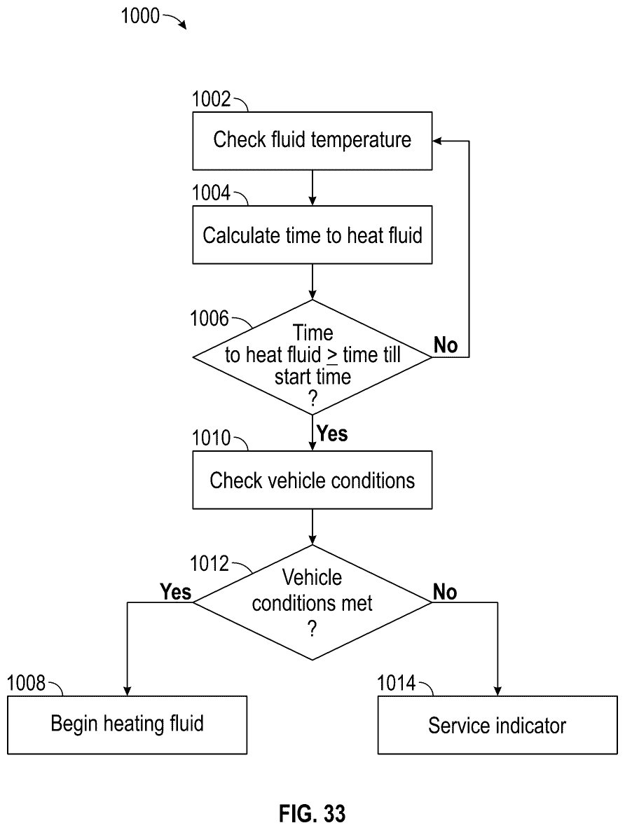

In some embodiments, as shown in FIG. 33, the method 1000 includes a step 1010 after the determination at step 1006 where the controller 800 checks the conditions of the vehicle 10 (e.g., location, battery status, fluid status, fluid level, etc.) and determines at step 1012 if the vehicle conditions for preheating are met prior to initiating the heating of the oil at step 1008. In some embodiments, the vehicle conditions for preheating include determining if a state of charge of the battery 23 and/or the battery 108 is above a threshold state of charge. If the state of charge is above the threshold state of charge, the controller 800 determines that the vehicle conditions are met. Alternatively or additionally, the vehicle conditions for preheating may include determining a location of the vehicle 10 (e.g., from a GPS sensor). If, for example, the vehicle 10 is parked at a warehouse, a parking lot, or another parking structure where the vehicle 10 returns after a planned route, the controller 800 may determine that the vehicle conditions for preheating are met. If the vehicle 10 is parked on a planned route, the controller may determine that the conditions for preheating are not met. Alternatively or additionally, the vehicle conditions for preheating may include determining if the level of the oil within the tank 114, for example, from the level sensor 902. If the oil within the tank 114 is at the correct level (e.g., plus or minus a predefined tolerance), the controller 800 may determine that the vehicle conditions are met. If the oil within the tank 114 is not at the correct level, the controller 800 may determine that the vehicle conditions are not met.

If the vehicle conditions are met at step 1012, the oil may proceed to be heated by the heater 920 at step 1008. If the vehicle conditions are not met at step 1012, one of the service indicator(s) 804 may be triggered at step 1014. By way of example, the service indicator 804 for not meeting the vehicle conditions may include a multi-purpose light, a dedicated light, a notification on a dashboard or the mobile device 816, a notification in an augmented reality overlay, and/or any of the service indicator(s) 804 for the tank 114 described herein.

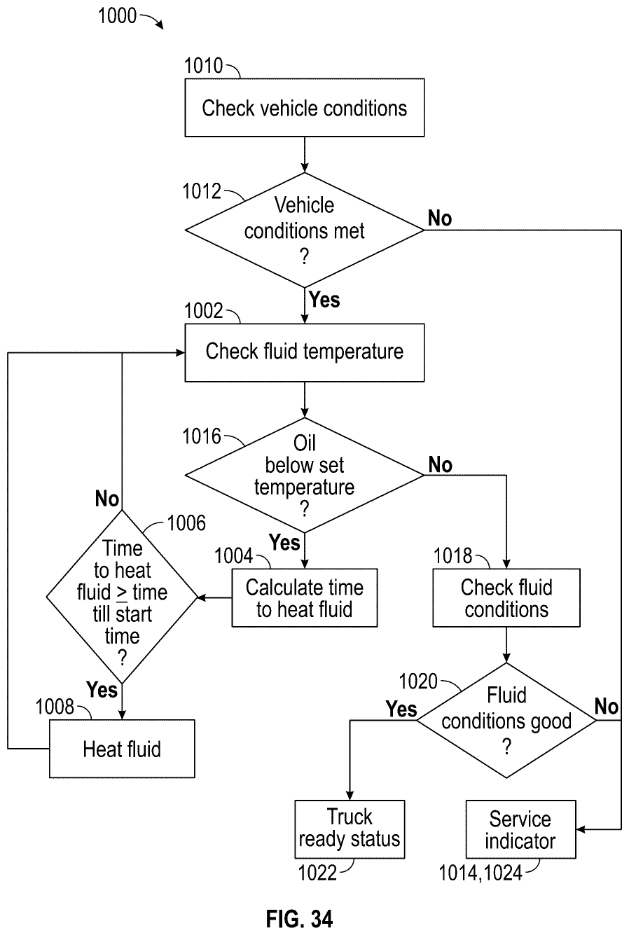

In some embodiments, as shown in FIG. 34, the method 1000 performs the check of the vehicle conditions at step 1010 and the determination of whether or not the vehicle conditions are met at step 1012 first and prior to checking the oil temperature at step 1002. Additionally, after checking the oil temperature at step 1002, the method 1000 may determine at step 1016 if the measured oil temperature is below a threshold temperature. If the oil is not below the threshold temperature, the fluid conditions are checked at step 1020 (e.g., oil level is at the correct level (plus or minus a predefined tolerance) from the level sensor 902, etc.). If the fluid conditions are acceptable at step 1020, the vehicle 10 is ready to operate at step 1022. If the fluid conditions are not acceptable at step 1018, one of the service indicator(s) 804 is triggered at step 1024 (e.g., any of the service indicator(s) 804 for the tank 114 described herein).

If the oil temperature is below the threshold temperature at step 1016, the time to heat the oil to the predetermined preheat temperature is calculated at step 1004. Again, if the time to heat the oil is approximately greater than or approximately equal to the time before the vehicle 10 starts, the heater 920 is instructed to heat the oil to the predetermined preheat temperature at step 1008. If the time to heat the oil is not approximately greater than or approximately equal to the time before the vehicle 10 starts, the method 1000 returns to step 1002 where the oil temperature is measured again.

Although this description may discuss a specific order of method steps, the order of the steps may differ from what is outlined. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the electromechanical variable transmission as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle comprising:
a chassis;
a body supported on the chassis;
a pump;
a tank configured to supply hydraulic fluid to the pump; and
a service indicator configured to provide an indication of a fluid level within the tank, wherein the service indicator includes a light, a graphic on a display, or a symbol in an augmented reality overlay, and wherein the service indicator is configured to provide the indication of the fluid level within the tank in response to a request signal.

2. The refuse vehicle of claim 1, wherein the service indicator is located remotely from the tank.

3. The refuse vehicle of claim 1, wherein the service indicator is the symbol in the augmented reality overlay.

4. The refuse vehicle of claim 1, wherein the service indicator includes a plurality of lights.

5. The refuse vehicle of claim 4, wherein the plurality of lights include an overfill light, a correct fill light, and a underfill light.

6. The refuse vehicle of claim 5, wherein the request signal triggers one of the overfill light, the correct fill light, and the underfill light to illuminate.

7. The refuse vehicle of claim 5, wherein the request signal is triggered by a button or switch.

8. The refuse vehicle of claim 7, wherein the button or switch is on a mobile device.

9. The refuse vehicle of claim 1, wherein the tank is arranged within an electronic power take off system.

10. A refuse vehicle comprising:
a chassis;
a body supported on the chassis;
a pump;
a tank configured to supply hydraulic fluid to the pump;
a temperature sensor configured to measure a temperature of the hydraulic fluid within the tank;
a heater arranged within the tank and configured to selectively heat the hydraulic fluid within the tank; and
a controller in communication with the temperature sensor and the heater, the controller being configured to:
measure, via the temperature sensor, the temperature of the hydraulic fluid within the tank;
determine if a time to heat the hydraulic fluid to a predetermined preheat temperature is greater than or equal to a time until a scheduled start time; and
upon determining that the time to heat the hydraulic fluid to the predetermined preheat temperature is greater than or equal to the time until the scheduled start time, instruct the heater to heat the hydraulic fluid in the tank to the predetermined preheat temperature.

11. The refuse vehicle of claim 10, wherein the controller is further configured to:
determine if a vehicle condition is met prior to instructing the heater to heat the hydraulic fluid.

12. The refuse vehicle of claim 11, wherein the vehicle condition includes a state of charge of a battery, a location of the refuse vehicle, or a fluid level within the tank.

13. The refuse vehicle of claim 11, further comprising a level sensor configured to measure a fluid level within the tank.

14. The refuse vehicle of claim 13, wherein the vehicle condition includes the fluid level of the hydraulic fluid within the tank.

15. The refuse vehicle of claim 10, wherein the controller is further configured to:
determine if the temperature of the hydraulic fluid is below a threshold temperature prior to determining if the time to heat the hydraulic fluid to the predetermined preheat temperature is greater than or equal to the time until the scheduled start time.

16. A method for preheating hydraulic fluid within a tank on a refuse vehicle, the method comprising:
measuring a temperature of hydraulic fluid within a tank on a refuse vehicle;
determining if a time to heat the hydraulic fluid to a predetermined preheat temperature is greater than or equal to a time until a scheduled start time of the refuse vehicle; and
upon determining that the time to heat the hydraulic fluid to the predetermined preheat temperature is greater than or equal to the time until the scheduled start time, heating the hydraulic fluid in the tank to the predetermined preheat temperature.

17. The method of claim 16, further comprising:
determining if a vehicle condition is met prior to heating the hydraulic fluid.

18. The method of claim 17, wherein the vehicle condition includes a state of charge of a battery, a location of the refuse vehicle, or a fluid level within the tank.

19. The method of claim 16, further comprising:
determining if the temperature of the hydraulic fluid is below a threshold temperature prior to determining if the time to heat the hydraulic fluid to the predetermined preheat temperature is greater than or equal to the time until the scheduled start time.

20. The method of claim 19, further comprising:
upon determining that the temperature of the hydraulic fluid is above the threshold temperature, determining if a fluid level within the tank is at a correct level.
